(19) United States
(12) Patent Application Publication
(10) Pub. No.: US 2004/0146838 A1
(43) Pub. Date: Jul. 29, 2004

(54) Dental composite filling

(76) Inventor: Martin Nugiel, Beit Shemesh (IL)

Correspondence Address: ANN M. KNAB, PENTRON CLINICAL TECHNOLOGIES, LLC, 53 NORTH PLAINS INDUSTRIAL ROAD, WALLINGFORD, CT, 06492, US

(21) Appl. No.: 10/353,607

(22) Filed: Jan. 29, 2003

(51) Int. Cl. A61C 5/04; A61C 7/00; A61C 3/00

(52) U.S. Cl. 433/226; 433/148; 433/153

(57) ABSTRACT

A method, with requisite tools, for producing a boat-shaped adhesive crust, contoured for dental composite filling, including steps of:

removing decay from a tooth, and exposing new tooth surfaces;

arranging a flexible metal band, supported by at least one wedge, around the tooth, so an inner surface of the metal band and new tooth surfaces form a cavity and provide a contour for the restored tooth;

applying acid solution to new tooth surfaces, dissolving inorganic material, leaving organic matrix on new tooth surfaces;

coating new tooth surfaces and the inner surface of the metal band with adhesive films;

providing a pressing tool having at least one tip;

pressing the coated metal band, with the tip, against an adjacent tooth, creating a desired contact area of the restored tooth; and

simultaneously with pressing, light-curing the adhesive films, forming the boat-shaped adhesive crust, having desired contact area and sufficient strength to maintain it, when the tip of the pressing tool is removed.

### CROSS-REFERENCE TO RELATED APPLICATIONS

This is a continuation-in-part application of international application number PCT/IL02/00419 filed May 30, 2002, and published Dec. 5, 2002 as international publication number WO 02/096312 A2, which claims priority to Israeli application no. 143454 filed on May 30, 2001 and Israeli application no. 147622 filed on Jan. 14, 2002, all the contents of which are incorporated herein by reference.

### FIELD OF THE PRESENT INVENTION

The present invention relates generally, to a tooth-colored dental composite filling. The present invention relates in particular, to a tooth-colored dental composite filling with improved contact areas between adjacent teeth.

### BACKGROUND OF THE PRESENT INVENTION

A large percentage of dental caries occurs between the teeth, just below the contact area, which is the point where two teeth contact each other. This may be seen in FIG. 1A, which schematically illustrates a side view of a tooth 14, showing caries 18, an adjacent tooth 12, and a contact area 16 between them. FIG. 1B schematically illustrates a cross-sectional view I-I of tooth 14, showing an enamel shell 25 and a dentine interior 23.

In the restoration of tooth 14, contact area 16 must be properly restored by recreating as closely as possible the natural contours of the original tooth. A desired contact area is clinically defined as one which provides a moderate resistance to dental floss. When the contact area is too strong, it is difficult to floss the teeth. When it is too weak, food will be caught between the teeth, leading to further decay, or food may be impacted between the teeth, causing damage to the supporting structures—bone and gum.

Tooth restoration may be better understood by first defining the surfaces of the tooth, schematically illustrated in FIG. 2, as well as in FIGS. 1A and 1B, as follows:

1. a chewing, or occlusal (O) surface 20;

2. a surface in contact with the tooth closer to the front of the mouth, or mesial (M) surface 22;

3. a surface in contact with the tooth closer to the back of the mouth, or distal (D) surface 24;

4. a surface on the side of the tongue, or lingual (L) surface 26; and

5. a surface on the side of the cheek, or buccal (B) surface 28.

Cavities are defined by the surfaces of the tooth which are affected by the restoration process, as follows:

1. Class I: Cavities in which dental caries 18 is limited to one, directly accessible surface. If the cavity is on occlusal surface 20, it is an O cavity; if the cavity is on lingual surface 26, it is an L cavity; if the cavity is on buccal surface 28, it is a B cavity.

2. Class II: Cavities in which dental caries 18 occurs on mesial surface 22 or distal surface 24 are MO or DO cavities, since access to surfaces 22 and 24 is made through occlusal surface 20. When access through occlusal surface 20 is minimal, for example, about 2×3 mm², the cavity is a slit MO or DO cavity. A cavity which occurs on both surfaces 22 and 24 is an MOD cavity.

FIGS. 3A-3G schematically illustrate a process of restoring tooth 14. As seen in FIG. 3A, restoration begins with the removal of dental caries 18. The dentist makes an access opening through occlusal surface 20 of tooth 14, and removes a portion 30 from tooth 14. Invariably, he also removes contact area 16

FIG. 3B illustrates tooth 14 after the removal of portion 30, exposing new tooth surfaces 32. New tooth surfaces 32 include at least one horizontal portion, for example, 32_{H1}, and possibly also 32_{H2} and at least one vertical portion, for example, 32_{V1} and possibly also 32_{V2}. Additionally, new tooth surfaces 32 include at least one corner, for example, 32_{C1} and possibly also 32_{C2}.

FIG. 3C illustrates a next stage in the restoration process of tooth 14. The dentist places a thin metal band 36 around tooth 14, made, for example, of stainless steel, and inserts a wedge 38 to support metal band 36. Together, metal band 36 and wedge 38 approach, albeit imperfectly, the original contours of tooth 14, and define a cavity 34 between new tooth surfaces 32 and metal band 36.

FIG. 3D illustrates a later stage of the restoration process, in which restorative material 48, such as silver amalgam, or tooth-colored dental composite is placed in cavity 34 while in a soft, plastic state. After the restorative material hardens, metal band 36 and wedge 38 are removed, and the restoration is functional.

FIG. 3E shows tooth 14 as viewed perspectively from the side adjacent to tooth 12. FIG. 3F shows teeth 12, 14 and 17 as viewed from the top and FIG. 3G shows tooth 14 as viewed from the side adjacent to tooth 12.

In a manner analogous to that illustrated in FIG. 3C, FIG. 4 schematically illustrates an MOD cavity 40, of a tooth 13, surrounded by metal band 36 and two wedges 38, inserted between tooth 13, a tooth 11 on its distal, and a tooth 15 on its mesial.

Until about 10 to 15 years ago, virtually all posterior restorations fabricated in the patient's mouth were made of silver amalgam. A major advantage of this material is that its working properties allowed it to be deformed under manual pressure, when soft, so that a desired contact area could be formed while in the soft state, and retained, as the silver amalgam hardened.

However, in recent years, tooth-colored dental composite fillings have become more popular and more in demand. These composite fillings have durability approaching or equal to that of silver amalgam. Their bonding process, in its most basic form, requires several steps, as follows:

1. After dental caries 18 is removed (FIG. 3A), an acid solution, for example 34% phosphoric acid, is administered with a small brush or a small synthetic sponge applicator (not shown) upon new tooth surfaces 32 (FIG. 3B), formed of dentine 23 and enamel 25 (FIG. 1B). The acid solution dissolves some of the inorganic material of tooth 14, and leaves an organic matrix on the dentine portion of new tooth surface 32.

2. After about 15-20 seconds, the acid solution is washed off with a water jet (not shown), and a primer is painted over new tooth surfaces 32, with a small brush or sponge applicator (not shown). The primer is a very low viscosity liquid which penetrates the interstices of the organic matrix.

3. When the primer is dried, an adhesive is painted over it, with a small brush or sponge applicator (not shown). The adhesive chemically combines with the primer to form a film 33 (FIG. 3C) of about 50-100μ over new tooth surfaces 32. As is known by persons familiar with the art, a recent development allows the application of the primer and the adhesive as a single mix, thereby forming film 33 in a single step. The thickness of the combined primer/adhesive layer using this newer system is generally thinner than that produced by the earlier method, approximately 10-20 microns and sometimes less.

4. Film 33 of adhesive (FIG. 3C), or of a mixture of primer and adhesive, is light cured, generally by a 600-milliwatt voltage halogen light (not shown), for 10-15 seconds, and hardens, bonding to the interstices of the organic matrix. As is known to those familiar with the art, it is the sensitivity of the adhesive and other dental materials to particular wavelengths of light that cure them and not the heating of the light.

5. After film 33 hardens, unhardened composite 48 (FIG. 3D) is applied and is light cured. The chemical composition of unhardened composite 48 is such that it chemically interacts with the adhesive of film 33. When unhardened composite 48 is light cured, it bonds with adhesive film 33; so that, as it hardens, it forms a composite filling which is firmly anchored against new tooth surfaces 32.

By chemically bonding to film 33 (FIG. 3D), which in turn is bonded to the interstices of the organic matrix of the tooth, composite 48 is bonded to the tooth. In contrast, silver amalgam does not bond to the tooth, chemically. Rather, the cavity is formed with a special shape, for example, with a wider distal portion with respect to an operator, than a proximal portion, so that the silver amalgam is mechanically locked in place. The chemical bonding feature of the tooth-colored dental composite filling provides dentists with a certain freedom as to the size and shape of the cavity.

FIG. 5 schematically illustrates a slit DO cavity 49, arranged for restoration. Slit cavity 49 is very narrow, affecting only about 2×3 mm² of the occlusal surface, so as to cause little trauma to the tooth. Slit cavities cannot be effectively restored with silver amalgam, giving tooth-colored dental composite filling a particular advantage over silver amalgam.

However, composite fillings suffer from a drawback as well. A major problem for the dentist is restoring a functional contact area. The silver amalgam is somewhat like a stiff dough, in that, when pressure is applied to it, in its soft form, it transmits the pressure to metal band 36, and pushes against the adjacent tooth, thereby hardening with the desired contact area. On the other hand, the unhardened composite does not have this property. The resulting contact area of a composite filling is often weak or open, and thus clinically unacceptable.

U.S. Pat. No. 5,318,446, “Tool and method for achieving consistent interproximal dental contacts,” to Slone, of Jun. 7, 1994, describes apparatus and method for preparing a tight contact between a tooth to be filled with a tooth-colored dental composite and an adjacent tooth, with the aid of a tool of a special shape, CONTACT PRO™, later improved into CONTACT PRO™ 2. The tool, CONTACT PRO™ 2, which is made of transparent material, especially for blue light, and which has a pointed end, is used as an aid in shaping the contact area. In essence, when using CONTACT PRO™ 2, the composite is administered in at least two stages. A first layer of unhardened composite is applied, and CONTACT PRO™ 2 is inserted into the composite layer, pressing metal band 36 against the adjacent tooth to form a desired contact area. The composite layer is then light cured, with the tool in place, so that it hardens with the desired contact area. CONTACT PRO™ 2 is then removed, and the hole formed by it in the first composite layer is filled with additional composite, generally of a lower viscosity than that of the first composite layer, in order that it fully penetrates the hole. After a second curing stage, another layer may be applied. This process may be repeated until the tooth is fully restored.

While the use of CONTACT PRO™ 2 or a similar tool provides a desired contact area, there are still a number of drawbacks associated with it. First, the recommended lower viscosity composite used for filling the hole formed by CONTACT PRO™ 2 may weaken the resulting composite filling somewhat. Second, the need for filling the hole, or two holes in a case of an MOD restoration having two contact areas, adds one or two extra stages to the restoration process, each of which requiring light curing for about 40 seconds, thereby significantly lengthening the restorative process. Third, CONTACT PRO™ 2 is generally too large for use with small cavities. Fourth, the contact formed using a hard pressing tool, like CONTACT PRO™ 2, is less true to the form and contour of a natural tooth than that formed using a soft pressing tool. In particular, a hard pressing tool results in a small, point contact between adjacent teeth.

### SUMMARY OF THE PRESENT INVENTION

The present invention seeks to provide a composite filling contoured for a desired contact area between adjacent teeth which is larger and wherein the restored interproximal surface of the tooth has a more physiological contour than that produced by the prior art.

A further aspect of the present invention relates to providing a tooth-colored dental composite filling, formed within a crust of adhesive, properly contoured for a desired contact area between adjacent teeth, without substantially lengthening the time required for the tooth restorative process.

Another aspect of the present invention relates to providing the desired contact areas on the two opposite sides of an MOD cavity in a single step.

Still another aspect of the present invention relates to providing a tooth-colored dental composite filling, having the desired contact area between adjacent teeth, for slit cavities.

There is thus provided, in accordance with the present invention, a method for producing a boat-shaped crust of adhesive, properly contoured for a dental composite filling, which includes the following steps:

removing decay from a tooth to be restored, and exposing new tooth surfaces formed of enamel and dentine;

arranging a flexible metal band, supported by at least one wedge, around the tooth, so that an inner surface of the metal band and the new tooth surfaces form a cavity and provide an approximate contour for the restored tooth;

applying an acid solution to the new tooth surfaces, to dissolve some of the inorganic material, leaving an organic matrix on the new tooth surfaces;

coating the new tooth surfaces with a first film of adhesive;

covering the inner surface of the metal band with a second film of adhesive;

providing a pressing tool having at least one tip;

pressing the coated metal band, with the at least one tip, against an adjacent tooth, to create a desired contact area of the restored tooth; and

simultaneously with the step of pressing, light curing the films of adhesive, thereby forming the boat-shaped crust of adhesive, having the desired contact area and having sufficient strength to maintain the desired contact area, when the at least one tip of the pressing tool is removed.

Additionally, in accordance with a preferred embodiment of present invention, the step of arranging a flexible metal band further includes the step of providing a flexible metal band which is substantially 65 mm in length, to encompass an adult molar tooth, and which is substantially 5 mm in height, the height being substantially 1 mm above the occlusal surface of the adjacent tooth, to afford a desired flexibility around the contact area.

Alternatively, the step of arranging a flexible metal band further includes the step of mechanically reducing the height of the flexible metal band, after it is arranged around the tooth, to a height which is substantially 1 mm above the occlusal surface of the adjacent tooth, to afford a desired flexibility around the contact area.

Additionally, in accordance with the preferred embodiment of present invention, in the step of coating, the first film of adhesive is a first film of a mixture of primer and adhesive, formulated as a single mixture.

Alternatively, the step of coating further includes the substep of coating the new tooth surfaces with a primer, prior to coating the new tooth surfaces with a first film of adhesive.

Additionally, in accordance with the present invention, the step of providing a pressing tool is providing a single-prong pressing tool, with the tip arranged at its distal end.

Alternatively, the step of providing a pressing tool includes providing a single-prong pressing tool, which includes:

a protrusion with the tip along its span, arranged to push the metal band against the adjacent tooth; and

a distal end, with respect to an operator, at a distance X from the protrusion, the distance X being somewhat greater than the distance between a corner of the new tooth surfaces and the location of the desired contact area,

wherein the method includes the following steps:

measuring the distance between the corner of the new tooth surfaces and the location of the desired contact area;

shortening distance X, by cutting off its distal end and forming a new distal end, so that when the new distal end is rested against the corner of the new tooth surface, the protrusion tip is arranged against the metal band, at the location of the desired contact area; and

resting the new distal tip against the corner of the new tooth surfaces, and pressing the metal band, with the tip, against the adjacent tooth.

In accordance with the preferred embodiment of the present invention, the step of providing a pressing tool having at least one tip is providing a pressing tool with two tips and an adjustable span between them, thereby forming first and second contact points with the cavity, substantially 180° apart,

wherein the pressing tool may be used for an MOD type cavity, and the first and second contact points may be made with the metal band, for simultaneously pressing the metal band against adjacent teeth on either side of the tooth to be restored, thus forming two of the desired contact areas in a single step,

and wherein the pressing tool may further be used for DO and MO type cavities, and while the first contact point is made with the metal band, pressing it against the adjacent tooth, to form the desired contact area, the second contact point is made with a portion of the new tooth surface. The method may further include a step of adjusting the span between the two tips with a resilient component, which may be tweezers-like, a coiled spring, or a squeezable pad. Alternatively, the resilient component may be arranged inside a piston-cylinder pressing tool.

Alternatively, the step of adjusting the span between the two tips is adjusting the span with screw-thread apparatus, having a first component which is selectably screw-threaded into and out of at least one other component.

Additionally, in accordance with the present invention, the step of providing a pressing tool includes providing a pressing tool, which includes:

two prongs, having proximal ends, with respect to an operator, and distal ends, with the tips at the distal ends, arranged to form the first and second contact points;

a hinge, which connects the two prongs, at the proximal ends; and

the screw-threaded apparatus, which includes:

the first component, being a screw-threaded rod;

the at least one other component, being two channels having inner threads, at about the midpoints of the two prongs, wherein the screw-threaded rod is arranged to be inserted through the two channels and mesh with the internal threads; and

a knob, mounted on the screw-threaded rod, between the two prongs, for turning the rod, thus selectably increasing and decreasing the span between the two tips.

Additionally in accordance with the present invention, the adjustable span is in a range between 5 and 20 mm.

In accordance with a preferred embodiment of the present invention, the step of pressing the coated metal band, with the at least one tip, includes pressing with at least one resilient, squeezable soft pad, mounted on the at least one tip of the pressing tool and which has preselected light transmission properties or is substantially transparent. Further, the soft pad is shaped as a hemisphere and has a diameter in a range between 1.0 and 3.5 mm and a thickness in a range between 0.5 and 3.0 mm.

Additionally, in accordance with a preferred embodiment of the present invention, the first film of adhesive and the second film of adhesive are of a same composition.

Further in accordance with the present invention, the cavity is one of a DO cavity, a slit DO cavity, an MO cavity, a slit MO cavity, and an MOD cavity.

There is thus also provided, method to produce a tooth-colored dental composite filling, formed within a crust of adhesive properly contoured for a desired contact area between adjacent teeth, produced by a method which includes the following steps:

employing a boat-shaped crust of adhesive as described hereinabove;

filling the boat-shaped crust of adhesive with an unhardened composite, which chemically interacts with the adhesive; and

light curing the unhardened composite, to harden it and form a dental composite filling, which is chemically bonded to the boat-shaped crust of adhesive and which has the desired contact area.

There is thus also provided, a method of producing a tooth-colored dental composite filling, formed within a crust of adhesive properly contoured for a desired contact area between adjacent teeth, which includes the following steps:

removing decay from a tooth to be restored, and exposing new tooth surfaces formed of enamel and dentine;

arranging a flexible metal band, supported by at least one wedge, around the tooth, so that an inner surface of the metal band and the new tooth surfaces form a cavity and provide an approximate contour for the restored tooth;

applying an acid solution to the new tooth surfaces, to dissolve some of the inorganic material, leaving an organic matrix on the new tooth surfaces;

coating the new tooth surfaces with a first film of adhesive;

covering the inner surface of the metal band with a second film of adhesive;

providing a pressing tool having at least one tip;

pressing the coated metal band, with the at least one tip, against an adjacent tooth, to create a desired contact area of the restored tooth;

simultaneously with the step of pressing, light curing the films of adhesive, thereby forming the boat-shaped crust of adhesive, having the desired contact area and having sufficient strength to maintain the desired contact area, when the at least one tip of the pressing tool is removed;

filling the boat-shaped crust of adhesive with an unhardened composite, which chemically interacts with the adhesive; and

light curing the unhardened composite, to harden it and form a dental composite filling, which is chemically bonded to the boat-shaped crust of adhesive and which has the desired contact area.

There is thus also provided, a flexible metal band, for use in dental restoration, which is substantially 60 or 65 mm in length, to encompass an adult molar tooth, and which is substantially 5 mm in height, with a gauge of substantially 0.001 inch to provide a desired flexibility for forming a desired contact area.

In accordance with a further preferred embodiment of the present invention, there is further provided a pressing tool, for use in dental restoration, which has a height in a range between 5 and 20 mm and a span in a range between 2 and 25 mm, and which is fabricated of materials having preselected light transmission properties or which are transparent. The pressing tool further includes at least one soft pad which is resilient and squeezable. It may be tweezer-like, compass-like, prong-like, or piston-cylinder-like in form. The prong-like pressing tool includes a shaft portion for engaging a tool holder and a beveled end providing an oblong surface, which may be fabricated with a concave contour, for engaging the soft pad. The piston-cylinder-like pressing tool includes an internal resilient component and has a span in a range between 7 and 25 mm.

### BRIEF DESCRIPTION OF THE DRAWINGS

The present invention will be more clearly understood from the accompanying detailed description and drawings, in which same number designations are maintained throughout the figures for like element and in which:

FIGS. 1A and 1B schematically illustrate side and cross-sectional views of a tooth;

FIG. 2 illustrates the surfaces of a tooth;

FIGS. 3A-3F schematically illustrate a process of restoring a DO cavity, in accordance with the prior art;

FIG. 4 schematically illustrates a process of restoring an MOD cavity, in accordance with the prior art;

FIG. 5 schematically illustrates a process of restoring a slit DO cavity, in accordance with the prior art;

FIGS. 6A and 6B compare, in a table format, a method of tooth restoration, in accordance with the present invention, with a conventional method of tooth restoration;

FIG. 7 schematically illustrates a DO cavity, prepared for restoration, in accordance with the present invention;

FIG. 8 schematically illustrates the use of a tweezers-like pressing tool, in the restoration of the DO cavity of FIG. 7, in accordance with a preferred embodiment of the present invention;

FIG. 9 schematically illustrates a subsequent stage in the restoration of the DO cavity of FIGS. 7 and 8, in accordance with the present invention;

FIGS. 10A-10C schematically illustrate a tweezers-like pressing tool and soft pads, in accordance with a preferred embodiment of the present invention;

FIG. 11 schematically illustrates the use of a tweezers-like pressing tool, in accordance with an alternate embodiment of the present invention;

FIG. 12 schematically illustrates the use of a tweezers-like pressing tool in the restoration of an MOD cavity, in accordance with a preferred embodiment of the present invention;

FIGS. 13A-13O schematically illustrate a number of views of a variety of pressing tools, in accordance with several embodiments of the present invention;

FIGS. 14A and 14B schematically illustrate the use of a single-prong pressing tool in a slit DO cavity, in accordance with a preferred embodiment of the present invention;

FIG. 15 schematically illustrates the use of single-prong pressing tool in a DO cavity, in accordance with the present invention;

FIG. 16 schematically illustrates a manner of adjusting an occlusal edge N of a metal band, in accordance with the preferred embodiment of the present invention; and

FIG. 17 schematically illustrates a metal band, having a length W and a height R, in accordance with the present invention.

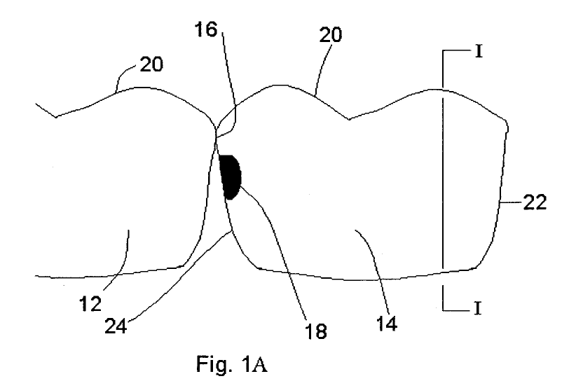

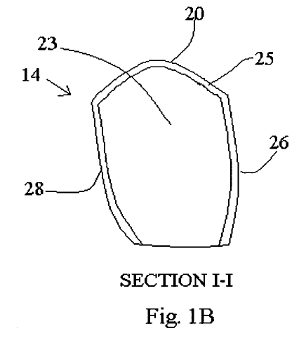

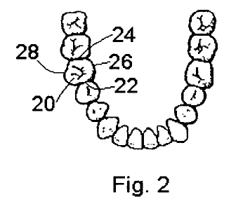

### DETAILED DESCRIPTION OF PREFERRED EMBODIMENTS

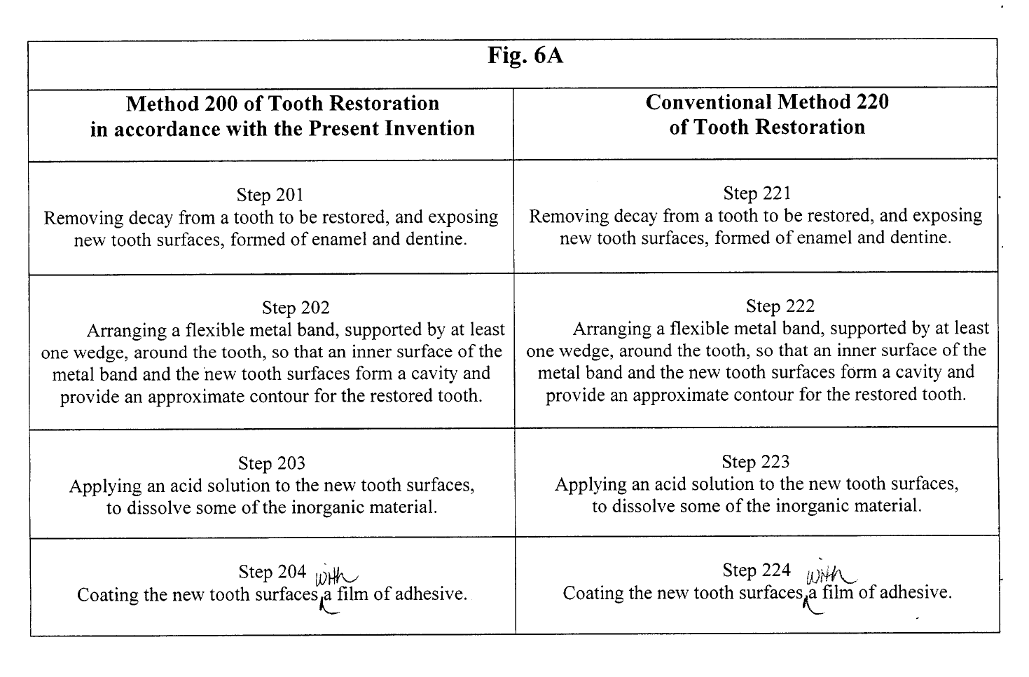

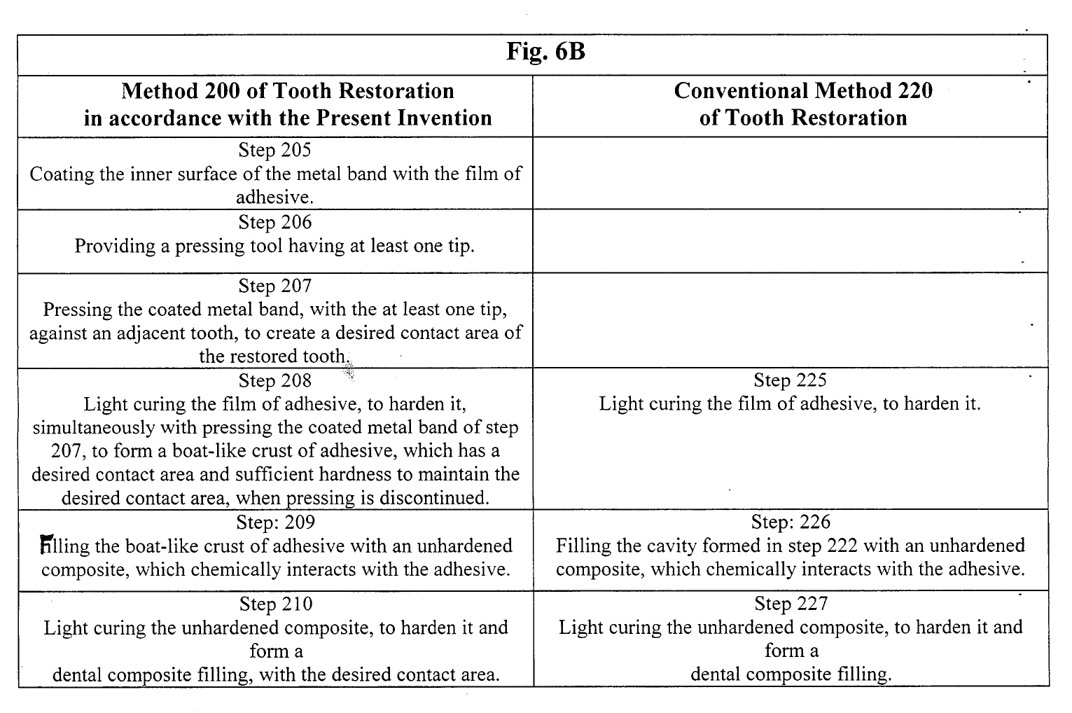

Reference is now made to FIGS. 6A-6B which indicate, in tabular form, the improvement of the present invention, by comparing a method 200 of tooth restoration, in accordance with the present invention, with a conventional method 220 of tooth restoration.

The first four steps of the two methods are similar, as shown in the table in FIG. 6A, as follows:

Step 201 (method 200 of the present invention) or 221 (conventional method 220):

Removing decay from a tooth to be restored, and exposing new tooth surfaces formed of enamel and dentine.

Step 202 (method 200 of the present invention) or 222 (conventional method 220):

Arranging a flexible metal band, supported by at least one wedge, around the tooth, so that an inner surface of the metal band and the new tooth surfaces form a cavity and provide an approximate contour for the restored tooth. The invention herein is not limited to metal bands, but may include any band made of metal, plastic or other flexible and resilient material.

Step 203 (method 200 of the present invention) or 223 (conventional method 220):

Applying an acid solution to the new tooth surfaces, to dissolve some of the inorganic material, leaving an organic matrix on the new tooth surfaces.

Step 204 (method 200 of the present invention) or 224 (conventional method 220):

Coating the new tooth surfaces with a film of adhesive. Coating may be performed by first coating the new tooth surfaces with a primer, and then coating over the primer with an adhesive, or by coating the new tooth surfaces with the primer and adhesive as a single mixture. As stated hereinabove, as is known by persons familiar with the art, use of a combined primer/adhesive mixture is a recent development in the art. It should thus be noted that, unless otherwise specified, further references herein to adhesive may refer to either adhesive or to a combined primer/adhesive mixture. Similarly, other developments as may become known in the art, such as further combining an acid solution with the primer/adhesive mixture, thereby combining steps 203 and 204 or 223 and 224 are also compatible with the present invention and should be considered alternative embodiments thereof.

As illustrated in FIG. 6B, the improvement of method 200 of the present invention is in the addition of steps 205-207, as follows:

Step 205:

Coating the inner surface of the metal band with the film of adhesive.

Step 206:

Providing a pressing tool having at least one tip.

Step 207:

Pressing the coated metal band, with the at least one tip, against an adjacent tooth, to create a desired contact area of the restored tooth.

It should be apparent to a person versed in the art, that added steps 205-207 of method 200 of the present invention do not lengthen the restoration process by more than a few seconds.

Method 200 of the present invention then proceeds in a manner analogous to conventional method 220, however, with significantly different results:

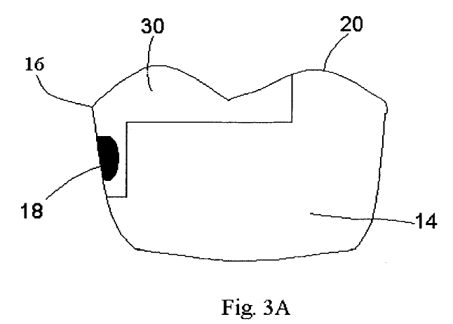

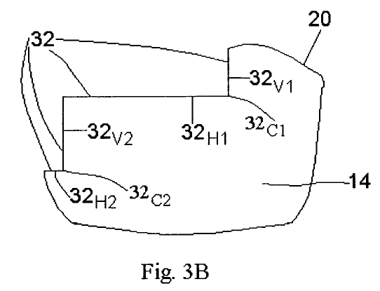

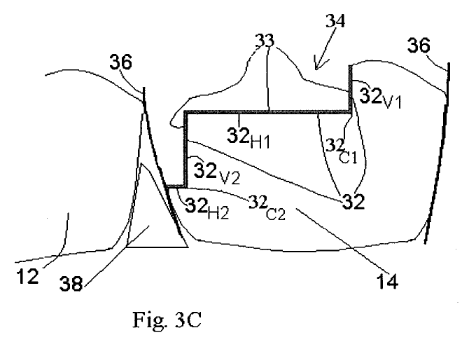

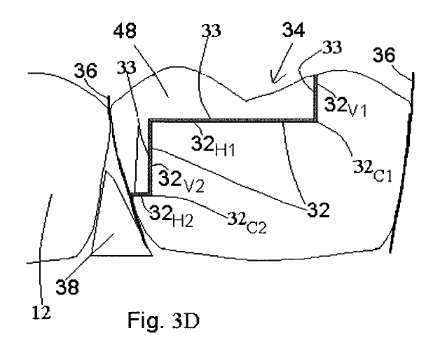

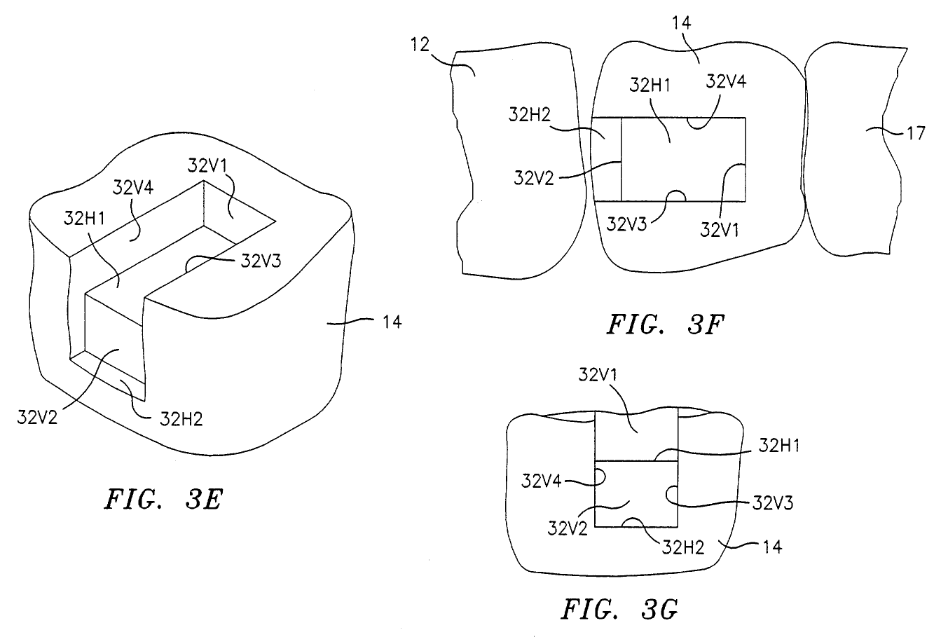

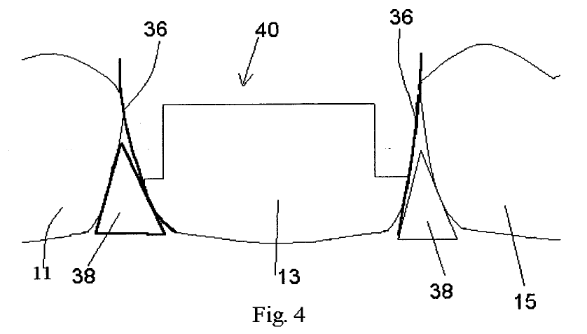

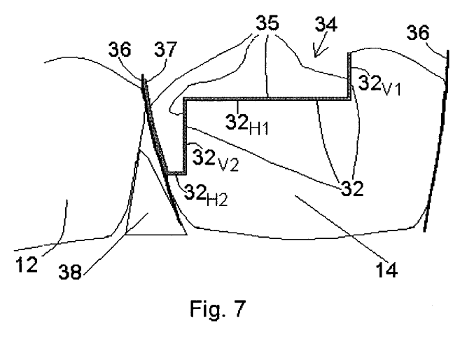

In contrast to step 225 (conventional method 220) of light curing the film of adhesive, to harden it, step 208 (method 200 of the present invention) requires light curing the film of adhesive, to harden it, simultaneously with the pressing the coated metal band of step 207, to form a boat-shaped crust of adhesive, which has the desired contact area and sufficient hardness to maintain the desired contact area, when pressing is discontinued. For both steps 225 (conventional method 220) and its analogous step 208 (method 200 of the present invention), light curing requires about 10-15 seconds. Boat-shaped is defined as having at least one side aligned along the side of the matrix band facing the prepared tooth and extending along the internal walls of the new tooth surfaces. For example, turning to FIG. 3E and FIG. 7, the boat-shaped crust is defined by walls 32V1, 32V2, 32V3, 32V4, 32H1, 32H2 and inner surface 37 of band 36. Boat-shaped is not limited to one shape, but includes all shapes formed by the surfaces that have been cut into the tooth to be restored in combination with the surface along the internal side of the matrix band. The shapes formed are considered boat-shaped because they form a vessel or cavity.

In contrast to step 226 (conventional method 220) of filling the cavity formed in step 222 with an unhardened composite, which chemically interacts with the adhesive, step 209 (method 200 of the present invention) requires filling the boat-shaped crust of adhesive with an unhardened composite, which chemically interacts with the adhesive.

Both steps 227 (conventional method 220) and step 210 (method 200 of the present invention) then require light curing the unhardened composite, to harden it and form a dental composite filling. However, in the case of conventional method 220, the composite filling has only an approximate contour for the resorted tooth, and frequently lacks the desired contact area, whereas, in the case of method 200 of the present invention, the composite filling acquires the contour of the boat-shaped crust of adhesive, with the desired contact area, produced by light curing the adhesive film coating the metal band, under pressure, in step 208.

Reference is now made to FIG. 7, which schematically illustrates DO cavity 34, prepared for restoration, in accordance with the present invention. In contrast to the prior art method of coating only new tooth surfaces 32 with film 33 (FIG. 3C) of adhesive, the present invention teaches coating both new tooth surfaces 32 and an inner surface 37 of metal band 36 with a film 35 of adhesive. Preferably, film 35 is of about 50-100μ, in thickness. Alternatively, it may be thinner. The primer and adhesive may be applied as separate fluids, or combined into a single mix. Film 35 of adhesive is basically of the same composition and viscosity as film 33 of FIG. 3C, and bonds with the interstices of the organic matrix of new dentine surfaces 32_{V1}, 32_{H1}, 32_{V2}, and 32_{H2}.

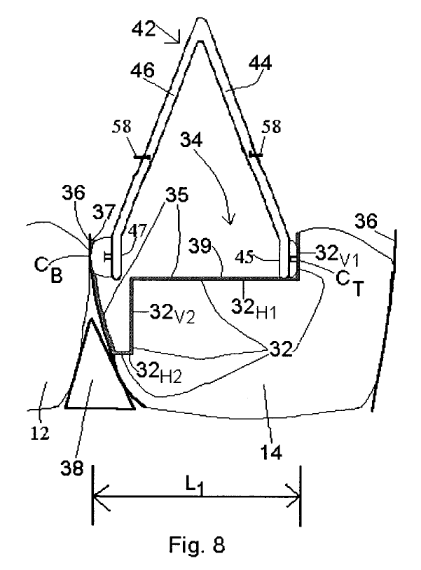

Reference is now made to FIG. 8, which schematically illustrates the use of a tweezers-like pressing tool 42, in the restoration of DO cavity 34, in accordance with a preferred embodiment of the present invention. Preferably, tweezers-like pressing tool 42 is resilient, having first and second prongs 44 and 46 and first and second tips 45 and 47. A span between first and second tips 45 and 47, when fully released, is somewhat larger than a span L₁ between surface 32_{V1} and adjacent tooth 12.

In accordance with the preferred embodiment of the present invention, after adhesive film 35 is applied, tweezers-like pressing tool 42 is inserted into cavity 34, with first and second tips 45 and 47 pressing against new tooth surface 32_{V1}, at a contact point C_{T}, and against inner surface 37, at a contact point C_{B}, respectively, pushing metal band 36, against adjacent tooth 12. Film 35 is then light cured. As it hardens, it forms a boat-shaped crust 39, contoured to have the desired contact area with respect to adjacent tooth 12.

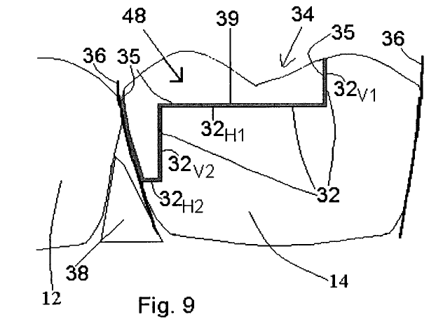

Reference is now made to FIG. 9, which schematically illustrates a next stage in the restoration of tooth 14, in accordance with the present invention. After film 35 hardens into boat-shaped crust 39, it maintains its contour, and maintains metal band 36 pressed against tooth 12, even as tweezers-like pressing tool 42 (FIG. 8), which does not interact with the adhesive, is removed. After its removal, boat-shaped crust 39 is filled with an unhardened composite 48, which is then light cured. Composite 48 chemically bonds with boat-shaped crust 39, and accepts its shape, maintaining the desired contact area with respect to adjacent tooth 12. It should be noted that at points C_{T} (FIG. 8) and C_{B}, between tweezers-like pressing tool 42 and film 35, boat-shaped crust 39 may be partially or completely perforated, as consequence of the pressure against film 35. However, this fact does not affect the integrity of the composite filling, as unhardened composite 48 fills these perforations.

After composite 48 hardens, metal band 36, which does not interact with film 35, and wedge 38 may be removed.

It is important to clearly point out the advantages of the present invention, when compared with CONTACT PRO™, CONTACT PRO™ 2, and similar tools of the prior art. While the prior art requires at least one additional stage of adding composite to fill the hole created by the tool, such as CONTACT PRO™, and curing the added composite for about 40 seconds, and two additional stages for MOD cavities, the present invention does not require any additional light curing stages.

Additionally, the manufacturer of CONTACT PRO™ 2 recommends using a low viscosity composite for filling the hole formed by CONTACT PRO™ 2, yet, this may weaken the composite filling. The use of low-viscosity composite is unnecessary with the present invention.

Additionally, the contact formed using a hard pressing tool, such as CONTACT PRO™ 2, is less true to the natural form and contour of a tooth. A hard pressing tool results in a small, point contact between adjacent teeth. The present invention uses a soft pad to shape the contact, which results in a larger contact area, and a more physiological contour to the restored interproximal surface of the tooth.

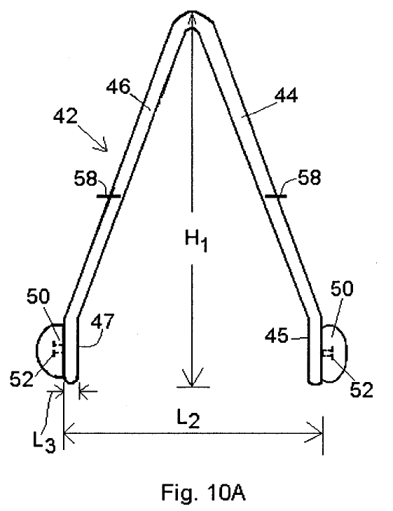

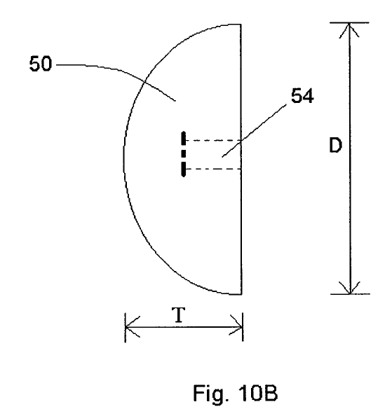

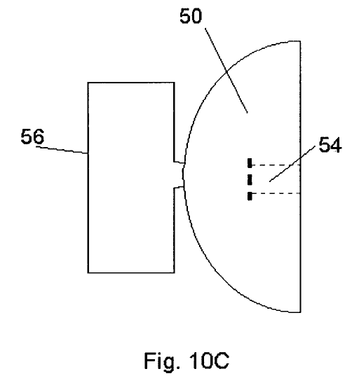

Reference is now made to FIG. 10A, which schematically illustrates tweezers-like pressing tool 42, in accordance with a preferred embodiment of the present invention. Tweezers-like pressing tool 42 may be formed, for example, of a resilient plastic, which may have preselected transmission properties with respect to halogen light, or be substantially transparent, or of a relatively opaque material such as a thin, resilient metal wire or any other known resilient material. Preferably, first and second prongs 44 and 46 include tips 45 and 47, having pins 52 for holding preferably soft pads 50, fabricated of a thermoplastic, rubber, Teflon, silicone or other nonsticky, rubbery material. It is important that the soft pads be fabricated of a material dissimilar to the adhesive being used, to prevent any type of adherence to the adhesive. Additionally, soft pads 50 may be adhered directly to tips 45 and 47. Preferably, soft pads 50 have preselected transmission properties with respect to halogen light or may be substantially transparent. The purpose of soft pads 50 is to flatten out slightly against metal band 36, and cause metal band 36 to form the desired contact area with respect to adjacent tooth 12. Thus, when using soft pads 50, contact points C_{B} and C_{T} (FIG. 8) are basically midpoints of the contact areas formed by the soft pads. Soft pad 50 associated with tip 45 may further provide a more stable hold against surface 32_{V1} of tooth 12. Preferably, tweezers-like pressing tool 42 further includes clips 58, to facilitate its manipulation with college pliers. Tweezers-like pressing tool 42 is resilient, and when fully released, a span L₂ between prongs 44 and 46, is greater than L₁ (FIG. 8). Thus, when inserted into cavity 34, pressure is applied by tweezers-like pressing tool 42, pushing metal band 36 against tooth 12. Preferably, tweezers-like pressing tool 42 may be provided in a range of sizes, for different size cavities. For example, a small tool, having a height, H₁, of substantially 10 mm and a span, L₂, of substantially 5 mm, a medium tool, for which H₁ is substantially 15 mm and L2 is substantially 13 mm, and a large tool, for which H₁ is substantially 15 mm and L2 is substantially 20 mm, may be provided. A cross-sectional thickness L₃ depends on the material, and may range from 0.3 to 3.0 mm, in diameter. However, tools of somewhat different dimensions may also be provided.

Reference is now also made to FIG. 10B, which schematically illustrates soft pad 50, in accordance with a preferred embodiment of the present invention. Preferably, soft pad 50 is largely hemispherical in shape, and may be provided in a range of sizes, suitable for different size cavities. For example, a diameter D in a range between 1.0 and 3.5 mm, in steps of 1 mm between sizes, and a thickness T in a range between 0.5 and 2 mm, in steps of 0.5 mm. Alternatively, somewhat different dimensions may be used. Additionally, soft pads of other shapes, for example, rectangular shapes, or conical shapes may be used, with cross-sectional areas similar to those listed above.

Pad 50 has defined therein a slit or hole 54, for its mounting over pins 52 of pressing tool 42 (FIG. 10A).

Reference is now also made to FIG. 10C, which further illustrates soft pad 50, in accordance with the present embodiment of the invention. Preferably, soft pad 50, which is small, is formed with a tab 56, to facilitate its handling. After mounting soft pad 50 over pin 52 of pressing tool 42 (FIG. 10A), tab 56 is removed, for example, with scissors.

In accordance with an alternative preferred embodiment of the present invention, soft pads 50 may be integrally formed with tips 45 and 47 of pressing tool 42, thereby eliminating the need to mount soft pads 50 thereon, and the risk of positional errors in doing so. Additionally, this obviates the need for pins 52 on pressing tool 42 and hole 54 and tab 56 in soft pads 50. It should be noted that the present embodiment employing integral construction of soft pads 50 with pressing tool 42 should be considered a preferred option for all pressing tools described herein or any tools included in the present invention.

As both tweezers-like pressing tool 42 and soft pads 50 may be provided in a range of sizes, to fit different dental situations, a dentist may have a plurality of combinations of tweezers and pads or integrally constructed combinations thereof to choose from.

In accordance with the preferred embodiment of the present invention, both pads 50 and tweezers-like pressing tool 42 are provided in a sterilized condition. Preferably, both are disposable, and made to use only once. Alternatively, only pads 50 are disposable, while tweezers-like pressing tool 42 may be used repeatedly and sterilized between applications. Alternatively both tweezers 42 and pads 50 may be used repeatedly and sterilized between applications.

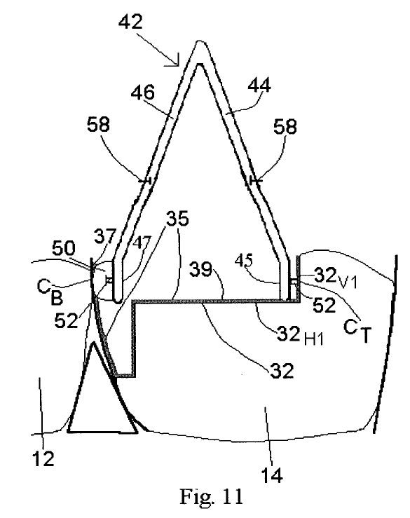

Reference is now made to FIG. 11, which schematically illustrates the use of tweezers-like pressing tool 42, in accordance with an alternate embodiment of the present invention, in which the dentist chooses to use soft pad 50 only on prong 46, against surface 37, but not on prong 44, against new tooth surface 32_{V1}. Pin 52 at the tip of prong 44 may be maintained, or removed.

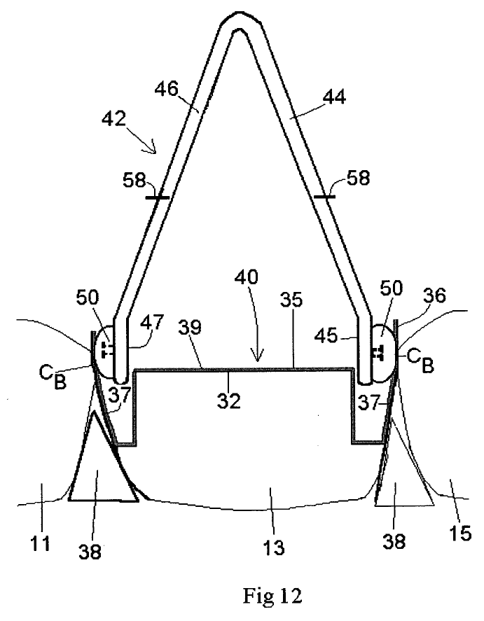

Reference is now made to FIG. 12, which schematically illustrates the use of tweezers-like pressing tool 42 in the restoration of an MOD cavity 40, in accordance with a preferred embodiment of the present invention. FIG. 12 highlights the advantage of tweezers-like pressing tool 42, for achieving the desired contact areas on the two sides of MOD cavity 40, in a single step. After the application of film 35, tweezers-like pressing tool 42 is inserted into cavity 40, pressing metal band 36 against both tooth 11 and tooth 15 simultaneously. When light cured, boat-shaped crust 39 is formed with the desired contact area with both teeth 11 and 15.

It is important to clearly point out the advantage of the present invention, when compared with CONTACT PRO™, CONTACT PRO™ 2, and similar tools, for MOD cavities. In accordance with the present invention, the two desired contact areas of MOD cavity 40, with both teeth 11 and 15, are achieved in a single step, unlike methods using the aforementioned tools, where each contact area must be achieved separately.

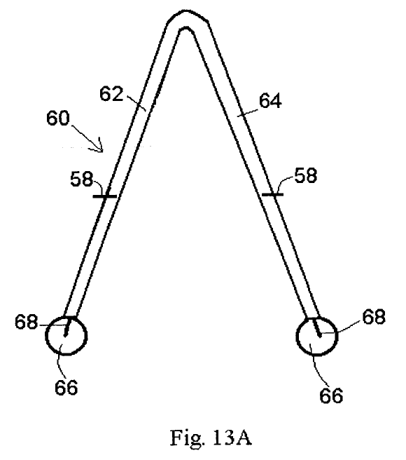

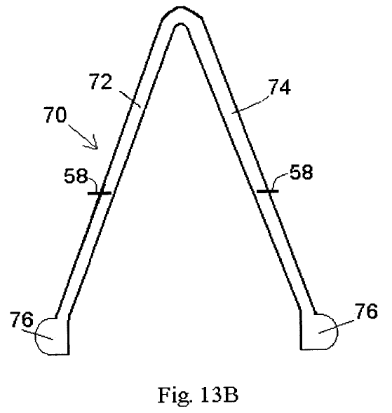

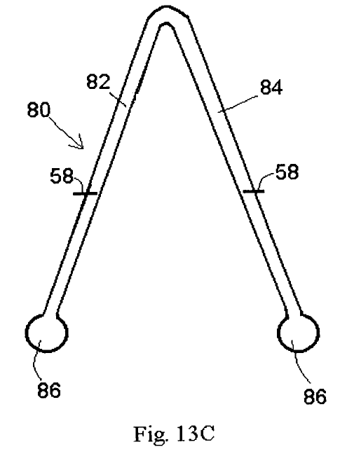

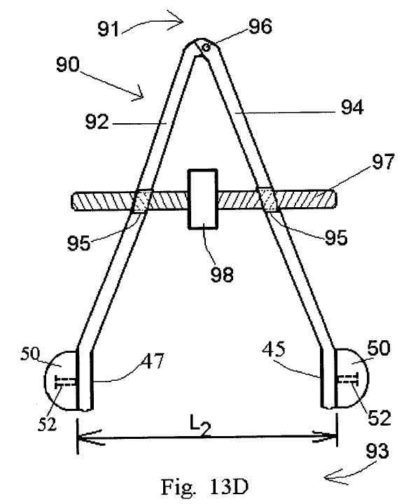

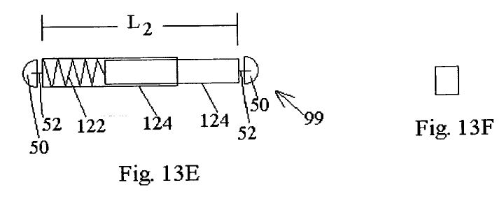

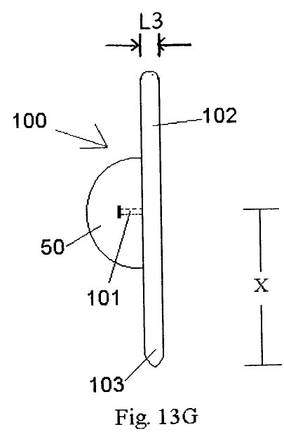

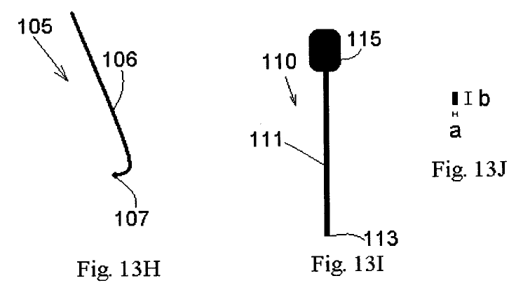

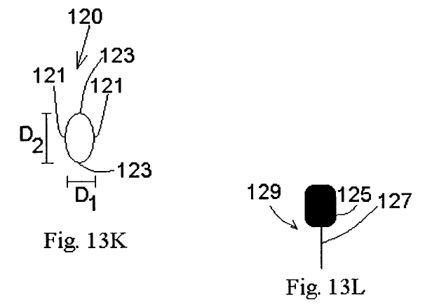

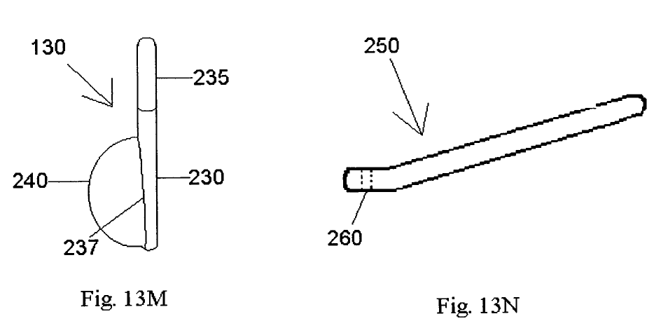

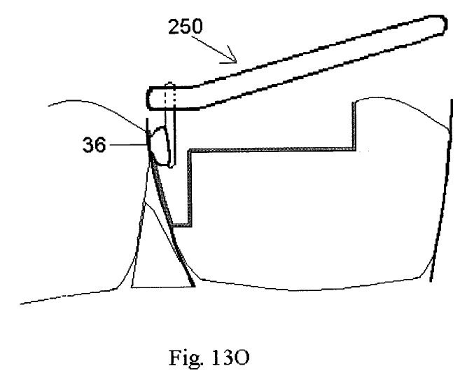

Reference is now made to FIGS. 13A-13O, which schematically illustrate a number of views of a variety of pressing tools, in accordance with several embodiments of the present invention.

FIG. 13A schematically illustrates a tweezers-like pressing tool 60, having first and second prongs 62 and 64, and having spherical soft pads 66, arranged on pins 68 at the tips of prongs 62 and 64. Soft pads 60 may be similar to soft pads 50 (FIG. 10B) but spherical.

FIG. 13B schematically illustrates a tweezers-like pressing tool 70, having first and second prongs 72 and 74, having tips 76, which are shaped as hemispheres. Tweezers-like pressing tool 70 is arranged for use with soft pads permanently adhered.

Similarly, FIG. 13C schematically illustrates a tweezers-like pressing tool 80, having first and second prongs 82 and 84, having tips 86, which are spherical. Tweezers-like pressing tool 80 is also arranged for use without soft pads.

Similarly, a tweezers-like pressing tool, having prongs with straight-edge tips (not shown), may be used.

FIG. 13D schematically illustrates a compass-like, two-prong, adjustable-span pressing tool 90, which is not resilient. Pressing tool 90 has first and second prongs 92 and 94, joined with a hinge 96, at a proximal end 91, with respect to an operator. Additionally, prongs 92 and 94 include first and second tips 45 and 47, which define span L₂ at a distal end 93, and include soft pads 50, mounted on pins 52 at distal end 93. Furthermore, prongs 92 and 94 are joined by a rod 97, which is inserted through channels 95 about midway along prongs 92 and 94. Rod 97 has a screw thread, and may be turned by a knob 98, at its midpoint. Channels 95 have internal threads, which complement the screw thread of rod 97. By rotating knob 98, span L₂ between prongs 92 and 94 at distal end 93 may be selectably increased or decreased, thus producing a desired pressure on metal band 36 (FIG. 8), when pressing tool 90 is inserted into cavity 34 (FIG. 8).

FIGS. 13E and 13F together, schematically illustrate a resilient, piston-cylinder adjustable-span pressing tool 99, having a cylinder 124c, a piston 124p inserted in cylinder 124c and a spring 122 loaded in cylinder 124c, which for example may be a coiled spring or an accordion-shaped spring, and arranged to press against metal band 36 (FIG. 8) and new tooth surfaces 32 (FIG. 8) with soft pads 50. The advantage of resilient, piston-cylinder pressing tool 99 is that it does not extend above the cavity, as it has very little height, analogous to H₁ (FIG. 10A) of tweezers-like pressing tool 42. Therefore, it may be used in the back of the mouth, where tweezers-like pressing tool 42 may be difficult to fit. Resilient, piston-cylinder pressing tool 99 may be used for DO, MO and MOD type cavities. Preferably, the cross-sectional configuration of piston-cylinder pressing tool 99 is of rectangular cross-section, as shown in FIG. 13F, to facilitate its manipulation with college pliers. In accordance with an alternative embodiment of the present invention, spring 122 may by itself be used as a pressing tool, preferably with soft pads mounted on either end thereof.

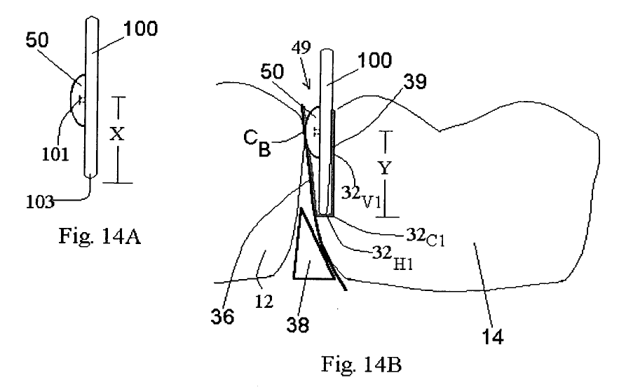

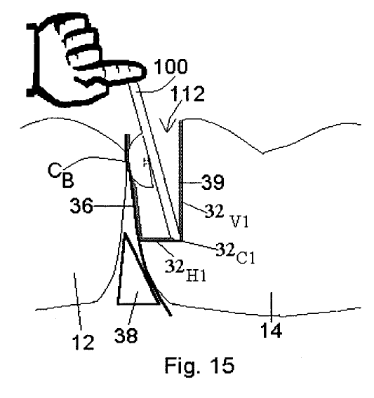

FIG. 13G schematically illustrates a pressing tool 100 having a single prong 102. Single-prong pressing tool 100 includes a pin 101 along its span, arranged to push metal band 36 against adjacent tooth 12, at a distance X from its distal end, with respect to an operator (not shown). A pad 50 may be mounted on pin 101 or alternatively, be integrally fabricated onto tool 100. Additionally, single-prong pressing tool 100 includes an edge 103 (could you please show where this (103) is in FIG. 13G; it is currently not shown) at its distal end. Single-prong pressing tool 100 further includes cross-sectional diameter L₃. The use of single prong pressure tool 100 will be demonstrated hereinbelow, in conjunction with FIGS. 14 and 15.

FIG. 13H schematically illustrates a pressing tool 105 having a single curved prong 106, with a tip 107, which a dentist may hold and press against metal band 36. Preferably, prong 105 has a rectangular cross section, to facilitate its manipulation with college pliers.

FIGS. 13I and 13J schematically illustrate a single-prong pressing tool 110, with a tip 113, which a dentist may hold and press against metal band 36. Preferably, single-prong pressing tool 110 has a rectangular cross section, a×b, shown in FIG. 13J, to facilitate its manipulation with college pliers. Preferably, single-prong pressing tool 110 is provided in a range of sizes, for example, with “a” ranging in size from 0.2 mm to 1.0 mm in steps of 0.2 mm and with “b” ranging in size from 0.5 mm to 1.5 mm in steps of 0.5 mm. Alternatively, single-prong pressing tool 110 may be round, having a cross-sectional diameter ranging in size, for example, from about 0.2 mm to 1 mm, in steps of 0.2 mm. Alternatively, single-prong pressing tool 110 may have an elliptical cross section, of dimensions similar, for example, to “a” and “b”. Alternatively, other dimensions, or other cross sections may be used. Single-prong pressing tool 110 may include a finger-gripping portion 115 at its proximal end with respect to an operator. A soft pad, such as soft pad 50 or soft pad 66 may be mounted at or adhered to tip 113 of single-prong pressing tool 110.

FIGS. 13K and 13L schematically illustrate a pressing tool 120, formed as an elliptical soft, squeezable pad 120, having tips 121, and 123 and diameters, D₁, and D₂. Preferably, soft pad 120 has preselected transmission properties with respect to halogen light or may be substantially transparent, made for example, of silicone. Soft pad 120 may be squeezed into a cavity, such as a slit DO or MO, or a standard DO or MO cavity, arranged with either tips 121, or tips 123 against contact points C_{B} (FIG. 8) and C_{T}, pressing metal band 36 against the adjacent tooth. Similarly, soft pad 120 may be squeezed into an MOD cavity, preferably, with tips 123 arranged against two contact points C_{B}'S. Preferably, soft pad 120 is provided in a range of sizes, for example, with D₁ ranging in size from 0.5 mm to 7 mm, in steps of 0.5 mm and with D₂ ranging in size from 1 mm to 20 mm, in steps of 1 mm. Alternatively, other dimensions may be used. In alternative embodiments of the invention, soft pad 120 may be formed in a different shape, for example, spherical, conical, or U shapes. Soft pad 120 may include a finger-gripping tool 129, (FIG. 13L), having a gripping portion 125 and a needle-like prong 127, which is arranged to pierce soft pad 120, for manipulating soft pad 120. For example, when tips 121 are used for pressing, needle-like prong 127 may be used to pierce one of tips 123, and when tips 123 are used for pressing, needle-like prong 127 may be used to pierce one of tips 121.

Referring now to FIGS. 13M, 13N, and 13O, there are shown schematic representations of a pressing tool (FIG. 13M), referred to generally as 130, constructed and operative in accordance with a particularly preferred embodiment of the present invention, a tool handle 250 to hold pressing tool 130 for use (FIG. 13N), and a schematic representation of their use (FIG. 13O) in accordance with the method of the present invention. Pressing tool 130 has a shank portion 235 which is substantially cylindrical so that it fits in hole 260 of and is held by tool handle 250 for use by the operator. The cylindrical shape of shank 235 of pressing tool 130 is given by way of example only, and other shapes suitable for use with tool handles with holes of other shapes, as may be used in the art, are included in the present invention. Pressing tool 130 further has a tool portion which is a single, largely cylindrical prong 230 which may preferably be tapered, having a beveled distal end to provide an oblong flat surface 237 to accommodate seating of soft pad 240 thereon. Flat surface 237 may preferably be hollowed slightly to a concave or spoon-like contour to better accommodate seating of soft pad 240 thereon. Preferably, soft pad 240 has preselected transmission properties with respect to halogen light or may be substantially transparent, which can be achieved by fabricating it of silicone, for example. Pressing tool 130 and tool handle 250 also preferably have preselected transmission properties with respect to halogen light or may be substantially transparent. FIG. 13O schematically illustrates the use of pressing tool 130 while inserted in handle 250 and pressing against metal band 36 in accordance with the present invention as described hereinabove for other embodiments thereof.

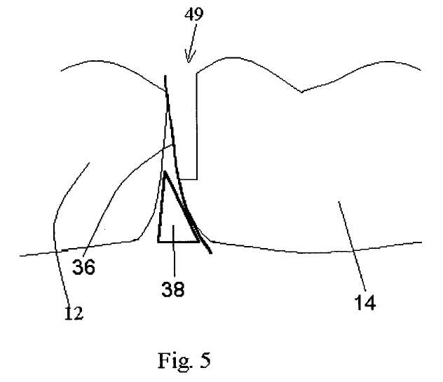

Pressing tools 42, 60, 70, 80, 90, 99, 100, 105, 110, 120, and 130 may be provided in a range of sizes, for different dental situations. They may be disposable, or may be sterilized between uses. Any of pressing tools 42, 60, 70, 80, 90, 99, 100, 105, 110, and 130 may be used with a soft pad such as soft pad 50 (FIG. 10B) or soft pad 66 (FIG. 13A), arranged at their tips or tips. Preferably the soft pads are disposable. In accordance with alternative preferred embodiments of the present invention, the soft pads may be integrally constructed with the pressing tools. In accordance with some embodiments of the present invention, any of pressing tools 42, 60, 70, 80, 90, 99, 100, 105, 110, and 130 may be formed of plastic, such as PETE (Polyethylene terephthalate), which is tough, highly resilient, and transparent, and which may be recycled. PETE is often used for packaging drinks and medicinal fluids. Alternatively, polycarbonate or ABS may be used. Preferably, pressing tools 42, 60, 70, 80, 90, 99, 100, and 105, 110, and 130 have preselected transmission properties with respect to halogen light or may be substantially transparent. Alternatively, they may be formed of metal, such as stainless steel, or a titanium alloy. In particular, single prong tools 100 (FIG. 13G), 105 (FIG. 13H) and 110 (FIGS. 13I and 13J), may be formed of metal and have cross-sectional dimensions of about 0.2-0.5 mm, so as to fit into slit cavity 49 (FIG. 5). The shadowing effect of an opaque tool, such as single prong tool 110 (FIGS. 13I and 13J), on adhesive film 35 (FIG. 7) will not interfere significantly with the desired light curing when the single-prong tool has a small cross-sectional diameter.

Reference is now made to FIGS. 14A and 14B, which schematically illustrate the use of single-prong pressing tool 100 for pressing metal band 36 against tooth 12, for proper contour of boat-shaped crust 39, in the restoration of slit DO cavity 49 in accordance with a preferred embodiment of the present invention. Slit cavity 49 includes new tooth surfaces 32_{V1} 32_{C1} and 32_{H1}. As seen in FIG. 14A, single-prong pressing tool 100 includes a pin 101 along its span, arranged to support pad 50 which pushes metal band 36 against adjacent tooth 12, at distance X from its distal end, with respect to an operator (not shown). Distance X is somewhat greater than a distance Y, seen in FIG. 14B, between new tooth surface 32_{H1} and point C_{B}, the location of the desired contact area. The operator may measure distance Y, between surface 32_{H1} and point C_{B}, and shorten X as necessary so that X=Y, by cutting off an edge 103 of single-prong pressing tool 100, to form a new edge at the distal end, so that when the new edge is rested against surface 32_{H1}, pin 101 and pad 50 are arranged against metal band 36, substantially at point C_{B}.

Preferably, single-prong pressing tool 100 includes a soft pad 50, mounted on pin 101. Slit cavity 49 is narrow enough so that when pressing tool 100 is rested with its distal end with respect to an operator on new tooth surface 32_{H1}, soft pad 50 provides the necessary pressure against metal band 36, and single-prong pressing tool 100 need not be held by the dentist. Alternatively, needle-like pressing tool 110 (FIG. 13I), held by the dentist, may be used, to press metal band 36 against tooth 12. Alternatively, soft pad 120 (FIG. 13K), may be inserted into cavity 49, to press metal band 36 against tooth 12.

It is important to clearly point out the advantage of the present invention, when compared with CONTACT PRO™ 2, for slit cavities. Generally, CONTACT PRO™ 2 is too large for a slit cavity, whereas the present invention includes pressing tools, such as pressing tools 100 (FIG. 13G), 110 (FIG. 13I), 120 (FIG. 13K), and 130 (FIG. 13M), which are designed with particular attention for slit cavities.

Reference is now made to FIG. 15, which schematically illustrates the use of single-prong pressing tool 100 for proper contour of boat-shaped crust 39, in the restoration of a DO cavity 112, in accordance with the present invention. Cavity 112, having new tooth surfaces 32_{V1}, 32_{C1}, and 32_{H1}, though not quite a slit cavity, may be too narrow for tweezers-like pressing tool 42 or its equivalent, and the dentist may choose to use pressure tool 100, and apply finger pressure against metal band 36. In accordance with alternative embodiments of the present invention, needle-like pressing tool 110 (FIG. 13I), or curved pressing tool 105 (FIG. 13H), held by the dentist, may be used, positioned for example against corner 32_{C1}, to press metal band 36 against tooth 12.

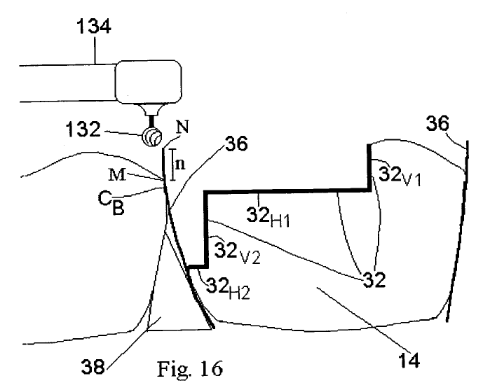

Reference is now made to FIG. 16, which schematically illustrates a manner of adjusting an occlusal edge N of metal band 36, in accordance with the preferred embodiment of the present invention. Defining a point M as the border between occlusal surface 20 and mesial surface 22 of adjacent tooth 12, then, for optimum contact area, edge N should be a distance n occlusal to point M, where n is about 1 mm, while point M should be occlusal to contact point C_{B}. The reason for this recommendation is that when edge N is occlusal to point M by more than about 1 mm, metal band 36 may not be sufficiently flexible to provide the desired contact area, and may offer too much resistance to pressing.

In accordance with the preferred embodiment of the present invention, after step 202 (FIG. 6A) of arranging metal band 36 around the tooth, if it is appears that edge N is occlusal to point M by more than about 1 mm, the excess may be removed with a large round bur 132 (FIG. 16) using a high speed dental hand piece 134. It is not necessary to remove the edge around the entire circumference of metal band 36. Rather, only the portion of metal band 36 which is against tooth 12, and portions that are about 1 to 2 millimeters more buccal and more lingual need to be removed. Any metallic debris can be washed away with a water jet.

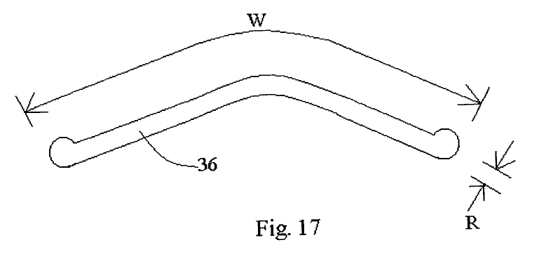

Reference is now made to FIG. 17, which schematically illustrates metal band 36, having a length W and a height R, in accordance with the present invention. For many restorations, the ideal height R of metal band 36 is that of a Tofflemire-type, stainless steel matrix band, sized Pedo #13, for which, length W is 60 mm, height R is 5 mm, and the gauge (thickness in the direction into the paper, not shown) is 0.001 inch.

However, for a large adult molar tooth, Pedo #13 length W of 60 mm may be too short, and Tofflemire-type, stainless steel ultra thin matrix band, #1, for which length W is 65 mm, height R is 6.5 mm, and gauge is 0.001 inch, should be used. The ultra-thin gauge of 0.001 inch provides a desirable greater flexibility to the band than the standard gauge of 0.0015 inch. When using standard #1 metal band 36, it may be necessary to reduce height R, as illustrated in FIG. 16.

Pedo #13 and ultra thin #1 metal bands 36 may be acquired for example, from Henry Schein Inc., Melville, N.Y. 11747, U.S.A.

In accordance with the preferred embodiment of the present invention, a special metal band 36, having length W of substantially 65 mm and height R of substantially 5 mm is provided, designed especially for adult molar teeth. These dimensions combine the height of Pedo #13 metal band with the length of standard #1 adult metal band, so as to eliminate the need to modify height R of metal band 36 in the mouth. A gauge of 0.001 inch should be used.

Additionally, in accordance with the preferred embodiment of the present invention, another design of special metal band 36 is provided, having length W of substantially 60 mm and height R of substantially 5 mm, and a gauge of 0.001 inch. These dimensions correspond to those of the standard Tofflemire-type Pedo #13 matrix band, but combines it with the gauge of an “ultra thin” band.

If the dentist wishes to restore adjacent teeth during a single visit, the suggested method is to restore a first tooth without forming a contact area, as there is no restored adjacent tooth for contact, and then restore the adjacent tooth in accordance with the teaching of the present invention.

It should be pointed out, that the pressing tools described hereinabove may also be used in a manner similar to CONTACT PRO™ 2. A first layer of unhardened composite is applied, and a pressing tool, such as 42, 60, 70, 80, 90, 99, 100, 105, 110, 120, or 130 is inserted into the composite layer, pressing metal band 36 against the adjacent tooth or teeth. Pressing tools such as 42, 60, 70, 80, 90, 99, 100, 105, 110 or 120 are advantageous over CONTACT PRO™ 2 in three respects: For MOD cavities, two contact areas may be formed in a single step, for slit cavities, fine pressing tools that are provided, and for all cavities, the restored interproximal surface produced has a more physiological contour and size.

It will be appreciated by persons skilled in the art that the scope of the present invention is not limited by what has been specifically shown and described hereinabove, merely by way of example. Rather, the scope of the present invention is limited solely by the claims, which follow.

What is claimed is:

1. A method to produce a boat-shaped crust of adhesive, properly contoured for a dental composite filling, said method including the following steps:
removing decay from a tooth to be restored, and exposing new tooth surfaces formed of enamel and dentine;
arranging a flexible band, supported by at least one wedge, around the tooth, so that an inner surface of the band and the new tooth surfaces form a cavity and provide an approximate contour for the restored tooth;
applying an acid solution to the new tooth surfaces, to dissolve some of the inorganic material, leaving an organic matrix on the new tooth surfaces;
coating the new tooth surfaces with a first film of adhesive;
covering the inner surface of the band with a second film of adhesive;
providing a pressing tool having at least one tip;
pressing the coated band, with the at least one tip, against an adjacent tooth, to create a desired contact area of the restored tooth; and
simultaneously with said step of pressing, light curing the first and second films of adhesive, thereby forming a boat-shaped crust of adhesive having the desired contact area and having sufficient strength to maintain the desired contact area when the at least one tip of the pressing tool is removed.

2. The method according to claim 1 wherein the flexible band is fabricated of a metal or plastic material.

3. The method according to claim 1, wherein said step of arranging a flexible band, further comprises the step of providing a flexible band which is substantially 65 mm in length, to encompass an adult molar tooth and which is substantially 5 mm in height, the height being substantially 1 mm above the occlusal surface of the adjacent tooth, thereby affording a desired flexibility around the desired contact area.

4. The method according to claim 1, wherein said step of arranging a flexible band, further comprises the step of mechanically reducing the height of the flexible band, after it is arranged around the tooth, to a height which is substantially 1 mm above the occlusal surface of the adjacent tooth, thereby affording a desired flexibility around the desired contact area.

5. The method according to claim 1, wherein in said step of coating, the first film of adhesive is a first film of a mixture of primer and adhesive, formulated as a single mixture.

6. The method according to claim 1, wherein said step of coating further comprises the substep of coating the new tooth surfaces with a primer, prior to coating the new tooth surfaces with a first film of adhesive.

7. The method according to claim 1, wherein said step of providing a pressing tool is providing a single-prong pressing tool, with the tip arranged at its distal end.

8. The method according to claim 7, wherein the single-prong pressing tool comprises:
a protrusion with the tip along its span, arranged to push the band against the adjacent tooth; and
a distal end, with respect to an operator, at a distance X from the protrusion, the distance X being somewhat greater than the distance between a corner of the new tooth surfaces and the location of the desired contact area,
and wherein said method further includes the following steps:
measuring the distance between the corner of the new tooth surfaces and the location of the desired contact area;
shortening distance X, by cutting off its distal end thereby forming a new distal end, so that when the new distal end is rested against the corner of the new tooth surface, the protrusion tip is arranged against the band, at the location of the desired contact area; and
resting the new distal tip against the corner of the new tooth surfaces, and pressing the band, with the tip, against the adjacent tooth.

9. The method according to claim 1, wherein said step of providing a pressing tool having at least one tip is providing a pressing tool with two tips and an adjustable span between them, thereby forming first and second contact points with the cavity, substantially 180° apart,
wherein the pressing tool may be used for a mesial occlusal distal type cavity, and the first and second contact points may be made with the band, for simultaneously pressing the band against adjacent teeth on either side of the tooth to be restored, thus forming two of the desired contact areas in a single step,
and wherein the pressing tool may further be used for distal occlusal and mesial occlusal type cavities, and while the first contact point is made with the band, pressing it against the adjacent tooth, to form the desired contact area, the second contact point is made with a portion of the new tooth surface.

10. The method according to claim 9, and further comprising the step of adjusting the span between the two tips with a resilient component.

11. The method according to claim 10, wherein, in said step of adjusting the span, the resilient component comprises tweezers.

12. The method according to claim 10, wherein, in said step of adjusting the span, the resilient component comprises a spring.

13. The method according to claim 12, wherein, in said step of adjusting the span, the spring comprises a coiled spring.

14. The method according to claim 10, wherein, in said step of adjusting the span, the resilient component comprises a squeezable pad.

15. The method according to claim 10, wherein, in said step of adjusting the span, the resilient component is arranged inside a piston-cylinder pressing tool.

16. The method according to claim 9 further comprising the step of adjusting the span between the two tips with screw-thread apparatus, having a first component which is selectably screw-threaded into and out of at least one other component.

17. The method according to claim 16, further comprising providing a pressing tool, which comprises:
two prongs, having proximal ends, with respect to an operator, and distal ends, with the tips at the distal ends, arranged to form the first and second contact points;
a hinge, which connects the two prongs, at the proximal ends; and
the screw-threaded apparatus, which includes:
the first component, being a screw-threaded rod;
the at least one other component, being two channels having inner threads, at about the midpoints of the two prongs, wherein the screw-threaded rod is arranged to be inserted through the two channels and mesh with the internal threads; and
a knob, mounted on the screw-threaded rod, between the two prongs, for turning the rod, thus selectably increasing and decreasing the span between the two tips.

18. The method according to claim 9, wherein, in said step of adjusting the span, the adjustable span is in a range between 5 and 20 mm.

19. The method according to claim 1, wherein said step of pressing the coated band, with the at least one tip, further comprises pressing with at least one soft pad which is resilient and squeezable, mounted on the at least one tip of the pressing tool.

20. The method according to claim 19, wherein, in said step of pressing, the soft pad is fabricated of materials having preselected light transmission properties.

21. The method according to claim 19, wherein, in said step of pressing, the soft pad is fabricated of materials which are substantially transparent.

22. The method of claim 21 wherein the soft pad is fabricated of a nonsticky, rubbery material.

23. The method of claim 21 wherein the soft pad is fabricated of thermoplastic, rubber, Teflon, or silicone material.

24. The method of claim 21 wherein the soft pad is fabricated of a material that is dissimilar to the adhesive.

25. The method according to claim 19, wherein, in said step of pressing, the soft pad is shaped as a hemisphere and has a diameter in a range between about 1.0 and about 3.5 mm.

26. The method according to claim 19, wherein, in said step of pressing, the soft pad is shaped as a hemisphere and has a thickness in a range between about 0.5 and about 3.0 mm.

27. The method according to claim 1, wherein, in said steps of coating and covering, the first film of adhesive and said second film of adhesive are of a same composition.

28. The method according to claim 1, wherein, in said step of arranging, the cavity is one of: a distal occlusal cavity, a slit distal occlusal cavity, a mesial occlusal cavity, a slit mesial occlusial cavity, and a mesial occlusal distal cavity.

29. A method to produce a tooth-colored dental composite filling, formed within a crust of adhesive properly contoured for a desired contact area between adjacent teeth, said method including the following steps:
employing a boat-shaped crust of adhesive produced in accordance with the method of claim 1;
filling the boat-shaped crust of adhesive with an unhardened composite, which chemically interacts with the adhesive; and
light curing the unhardened composite, to harden it and form a dental composite filling, which is chemically bonded to the boat-shaped crust of adhesive and which has the desired contact area.

30. A method to produce a tooth-colored dental composite filling, formed within a crust of adhesive, properly contoured for a desired contact area between adjacent teeth, said method including the following steps:
removing decay from a tooth to be restored, and exposing new tooth surfaces formed of enamel and dentine;
arranging a flexible band, supported by at least one wedge, around the tooth, so that an inner surface of the band and the new tooth surfaces form a cavity and provide an approximate contour for the restored tooth;
applying an acid solution to the new tooth surfaces, to dissolve some of the inorganic material, leaving an organic matrix on the new tooth surfaces;
coating the new tooth surfaces with a first film of adhesive;
covering the inner surface of the band with a second film of adhesive;
providing a pressing tool having at least one tip;
pressing the coated band, with the at least one tip, against an adjacent tooth, to create a desired contact area of the restored tooth;
simultaneously with the step of pressing, light curing the first and second films of adhesive, thereby forming the boat-shaped crust of adhesive having the desired contact area and having sufficient strength to maintain the desired contact area when the at least one tip of the pressing tool is removed;
filling the boat-shaped crust of adhesive with an unhardened composite, which chemically interacts with the adhesive; and
light curing the unhardened composite, to harden it and form a dental composite filling, which is chemically bonded to the boat-shaped crust of adhesive and which has the desired contact area.

31. The method of claim 30 wherein the flexible band is fabricated of a metal or plastic material.

32. A pressing tool, for use in dental restoration, comprising tweezers having two prongs, wherein a soft pad is positioned on an end of at least one of the two prongs, and wherein the two prongs have a height in a range between 5 and 20 mm and a span between the two ends in a range between 2 and 25 mm.

33. The pressing tool of claim 32 wherein the tweezers are fabricated of a resilient material.

34. The pressing tool of claim 33 wherein the resilient material is selected from the group consisting of metal and plastic.

35. The pressing tool according to claim 32, which is fabricated of materials having preselected light transmission properties.

36. The pressing tool according to claim 32, which is fabricated of materials which are substantially transparent.

37. The method of claim 32 wherein the soft pad is fabricated of a nonsticky, rubbery material.

38. The method of claim 32 wherein the soft pad is fabricated of thermoplastic, rubber, Teflon, or silicone material.

39. The method of claim 32 wherein the soft pad is fabricated of a material that is dissimilar to the adhesive.

40. A pressing tool according to claim 32, wherein the soft pad is resilient and squeezable.

41. The pressing tool of claim 32 wherein the soft pad is spherical, hemispherical, rectangular, or conical in shape.

42. The pressing tool of claim 32 wherein the at least one of the two prongs comprises a pin projecting therefrom and whereby the soft pad is mounted on the pin.

43. The pressing tool of claim 32 wherein the soft pad is formed integrally on the at least one of the two prongs.

44. The pressing tool of claim 32 wherein the soft pad is removable.

45. A pressing tool, for use in dental restoration, comprising a V-shaped body having two prongs connected at one end with a hinge to form the V-shaped body, a rod inserted through the two prongs, wherein the rod comprises a screw thread for increasing and decreasing a span between the two prongs, and a knob positioned on the rod for turning the rod.

46. The pressing tool of claim 45 further comprising a soft pad positioned on an end of at least one of the two prongs.

47. The pressing tool according to claim 45, which is fabricated of materials having preselected light transmission properties.

48. The pressing tool according to claim 45, which is fabricated of materials which are substantially transparent.

49. The method of claim 46 wherein the soft pad is fabricated of a nonsticky, rubbery material.

50. The method of claim 46 wherein the soft pad is fabricated of thermoplastic, rubber, Teflon, or silicone material.

51. The method of claim 46 wherein the soft pad is fabricated of a material that is dissimilar to the adhesive.

52. A pressing tool according to claim 46, wherein the soft pad is resilient and squeezable.

53. The pressing tool of claim 46 wherein the soft pad is spherical, hemispherical, rectangular, or conical in shape.

54. The pressing tool of claim 46 wherein the at least one of the two prongs comprises a pin projecting therefrom and whereby the soft pad is mounted on the pin.

55. The pressing tool of claim 46 wherein the soft pad is formed integrally on the at least one of the two prongs.

56. The pressing tool of claim 46 wherein the soft pad is removable.

57. A pressing tool for use in dental restoration comprising a shank having a proximal and distal end, whereon the distal end comprises a soft pad and wherein the distal end is connected to a handle.

58. The pressing tool of claim 57 wherein the handle comprises an opening for insertion of the shank therein.

59. The pressing tool of claim 57 wherein the contour of the shank corresponds to the contour of the opening in the handle.

60. The pressing tool of claim 57 wherein the contour of the shank is cylindrical.

61. The pressing tool of claim 57 wherein the shank comprises a beveled surface on its distal end.

62. The pressing tool of claim 61 wherein the beveled surface is an oblong flat surface.

63. The pressing tool of claim 62 wherein the soft pad is positioned on the oblong flat surface.

64. A pressing tool according to claim 62, wherein said oblong surface is fabricated with a concave contour.

65. The pressing tool according to claim 57 wherein the shaft is fabricated of materials having preselected light transmission properties.

66. The pressing tool according to claim 57 wherein the shaft is fabricated of materials which are substantially transparent.

67. A pressing tool according to claim 57, wherein the soft pad is resilient and squeezable.

68. The pressing tool of claim 57 wherein the soft pad is spherical, hemispherical, rectangular, or conical in shape.

69. The method of claim 57 wherein the soft pad is fabricated of a nonsticky, rubbery material.

70. The method of claim 57 wherein the soft pad is fabricated of thermoplastic, rubber, Teflon, or silicone material.

71. The method of claim 57 wherein the soft pad is fabricated of a material that is dissimilar to the adhesive.

72. The pressing tool of claim 57 wherein the shank comprises a pin projecting therefrom and whereby the soft pad is mounted on the pin.

73. The pressing tool of claim 57 wherein the soft pad is formed integrally on the shank.

74. The pressing tool of claim 57 wherein the soft pad is removable.

75. A pressing tool for use in dental restoration comprising a cylinder, a piston positioned in the cylinder, an internal resilient component loaded in the cylinder, and a soft pad positioned on at least one of an end of the cylinder or piston, and wherein the internal resilient component has a span in a range between 7 and 25 mm.

76. The pressing tool of claim 75 wherein the internal resilient component comprises a coiled spring or an accordion-shaped spring.

77. A pressing tool for use in dental restoration comprising a single prong and a soft pad mounted on the single prong.

78. The pressing tool of claim 77 wherein the single prong is curved at one end.

79. The pressing tool of claim 77 wherein the single prong has a height in the range between 5 and 20 mm.

80. The method of claim 77 wherein the soft pad is fabricated of a nonsticky, rubbery material.

81. The method of claim 77 wherein the soft pad is fabricated of thermoplastic, rubber, Teflon, or silicone material.

82. The method of claim 77 wherein the soft pad is fabricated of a material that is dissimilar to the adhesive.
